(19) United States
(12) Patent Application Publication
(10) Pub. No.: US 2014/0028276 A1
(43) Pub. Date: Jan. 30, 2014

(54) INTERNAL VOLTAGE GENERATOR HAVING IMMUNITY TO GROUND BOUNCING

(71) Applicant: SK HYNIX INC., Gyeonggi-do (KR)

(72) Inventor: Je-Il RYU, Gyeonggi-do (KR)

(73) Assignee: SK HYNIX INC., Gyeonggi-do (KR)

(21) Appl. No.: 13/717,141

(22) Filed: Dec. 17, 2012

(30) Foreign Application Priority Data
Jul. 30, 2012 (KR) 10-2012-0083161

(51) Int. Cl. G05F 1/10

(52) U.S. Cl. CPC G05F 1/10
USPC 323/282

(57) ABSTRACT

An internal voltage generator includes a comparison unit configured to compare a voltage level of a feedback voltage with a reference voltage to generate an enable signal based on a result of the comparison; an internal voltage generation unit configured to generate an internal voltage in response to the enable signal; a voltage detection unit configured to generate a control signal by detecting a voltage level of a power source voltage; and a feedback unit configured to generate the feedback voltage by dividing the internal voltage at a given resistance ratio, wherein the feedback unit continuously maintains a difference between the voltage levels of the power source voltage and the internal voltage in response to the control signal.

### CROSS-REFERENCE TO RELATED APPLICATION

The present application claims priority of Korean Patent Application No. 10-2012-0083161, filed on Jul. 30, 2012, which is incorporated herein by reference in its entirety.

### BACKGROUND

1. Field

Exemplary embodiments of the present invention relate to semiconductor design technology, and more particularly, to an internal voltage generator for generating an internal voltage.

2. Description of the Related Art

In general, a semiconductor device including double data rate synchronous DRAM (DDR SDRAM) is provided with an internal voltage generator for generating internal voltages. The semiconductor device achieves more efficient power consumption and stable circuit operation by using the internal voltages having a variety of voltage levels. Typically, the semiconductor devices generate the internal voltages through a charging pumping method or voltage down converting method, using an external power supply voltage VDD, and an external ground voltage VSS. In the case of DRAM, the internal voltages generated by the charge pumping method may include a boost voltage VPP, a substrate bias voltage VBB and the like. Furthermore, the internal voltages generated by the voltage down converting method may include a core voltage VCORE, a bit line precharge voltage VBLP and the like.

Meanwhile, with an increase in the degree of integration of semiconductor devices, a design rule of a sub-micron level or lower is being applied to internal circuits, and thus, the level of the external power supply voltage should be lowered for operating the internal circuit at a high speed. Accordingly, it is important to generate a stable internal voltage using a low power supply voltage. In particular, the internal voltage generated by the charge pumping method may greatly fluctuate according to a minute shift in the external power supply voltage and the external ground voltage. Thus, it may be necessary to provide sufficient attention to designing a circuit for generating the internal voltage.

FIG. 1 is a block diagram of a conventional internal voltage generator.

Referring to FIG. 1, the conventional internal voltage generator includes a comparison unit 110, a pumping unit 120, and a feedback unit 130.

The comparison unit 110 compares a voltage level of a feedback voltage V_FED with a reference voltage V_REF and generates an enable signal EN based on a result of the comparison. The pumping unit 120 generates an internal voltage V_INN through a pumping operation in response to the enable signal EN. The feedback unit 130 generates the feedback voltage V_FED by dividing the internal voltage V_INN at a resistance ratio of first and second resistors R1 and R2 and provides the feedback voltage V_FED to the comparison unit 110.

Here, the voltage level of the internal voltage V_INN may be ideally defined by Equation 1 below.

V_INN=(1+R2/R1)*V_FED <Equation 1>

As can be seen from Equation 1, the internal voltage V_INN may be defined by a resistance ratio of the first and the second resistors R1 and R2.

Meanwhile, the voltage level of the external ground voltage VSS may bounce due to several reasons. When the external ground voltage VSS bounces, the voltage level of the internal voltage V_INN may be defined by Equation 2 below.

V_INN=(1+R2÷R1)×V_FED−(R2÷R1×VSS_BOUNCING) <Equation 2>

In Equation 2, ‘VSS_BOUNCING’ means a voltage level when the external ground voltage VSS bounces. As can be seen from Equation 2, when the external ground voltage VSS bounces, the voltage level of the internal voltage V_INN may be lowered corresponding to ‘VSS_BOUNCING’.

FIG. 2 is a timing diagram illustrating the intern voltage V_INN shown in FIG. 1 when the ground bouncing occurs.

Referring to FIG. 2, it can be seen that the voltage levels of the external ground voltage VSS bounces in a section T, and thus, the voltage level of the internal voltage V_INN is lowered, and the voltage difference between both voltages does not remain constant. Furthermore, the unstable change of the internal voltage V_INN causes malfunction of a circuit that uses the internal voltage V_INN.

### SUMMARY

Exemplary embodiments of the present invention are directed to an internal voltage generator for generating stable internal voltages even when a ground bouncing affects an external ground voltage.

In accordance with an embodiment of the present invention, an internal voltage generator includes a comparison unit configured to compare a voltage level of a feedback voltage with a reference voltage to generate an enable signal based on a result of the comparison; an internal voltage generation unit configured to generate an internal voltage in response to the enable signal; a voltage detection unit configured to generate a control signal by detecting a voltage level of a power source voltage; and a feedback unit configured to generate the feedback voltage by dividing the internal voltage at a given resistance ratio, wherein the feedback unit continuously maintains a difference between the voltage levels of the power source voltage and the internal voltage in response to the control signal.

In accordance with another embodiment of the present invention, an internal voltage generator may include a comparison unit configured to compare a voltage level of a feedback voltage with a reference voltage to generate an enable signal based on a result of the comparison; an internal voltage generation unit configured to generate an internal voltage in response to the enable signal; a voltage detection unit configured to generate a control signal by detecting a voltage level of a power source voltage; a voltage divider configured to generate the feedback voltage by incorporating a given resistance ratio into the internal voltage; and a controller configured to control the given resistance ratio in response to the control signal.

In accordance with yet another embodiment of the present invention, an internal voltage generator may include a comparison unit configured to compare a voltage level of a feedback voltage with a reference voltage to generate an enable signal based on a result of the comparison; an internal voltage generation unit configured to generate an internal voltage in response to the enable signal; a voltage detection unit configured to generate a control signal by detecting a voltage level of a power source voltage; a voltage divider configured to generate the feedback voltage by dividing the internal voltage at a given resistance ratio; and a controller configured to control a capacitance component, incorporated into a feedback voltage terminal in response to the control signal.

An internal voltage generator in accordance with an embodiment of the present invention may generate a stable internal voltage even when the external ground voltage bounces.

### BRIEF DESCRIPTION OF THE DRAWINGS

FIG. 1 is a block diagram of a conventional internal voltage generator.

FIG. 2 is a timing diagram illustrating the internal voltage V_INN shown in FIG. 1 when the ground bouncing occurs.

FIG. 3 is a block diagram of an internal voltage generator in accordance with an embodiment of the present invention.

FIG. 4 is a detailed diagram illustrating a voltage detection unit shown in FIG. 3.

FIG. 5 is a detailed diagram illustrating a first embodiment of a feedback unit shown in FIG. 3.

FIG. 6 is a diagram illustrating the internal voltage V_INN shown in FIG. 5 when the ground bouncing occurs.

FIG. 7 is a detailed diagram illustrating a second embodiment of the feedback unit show in FIG. 3.

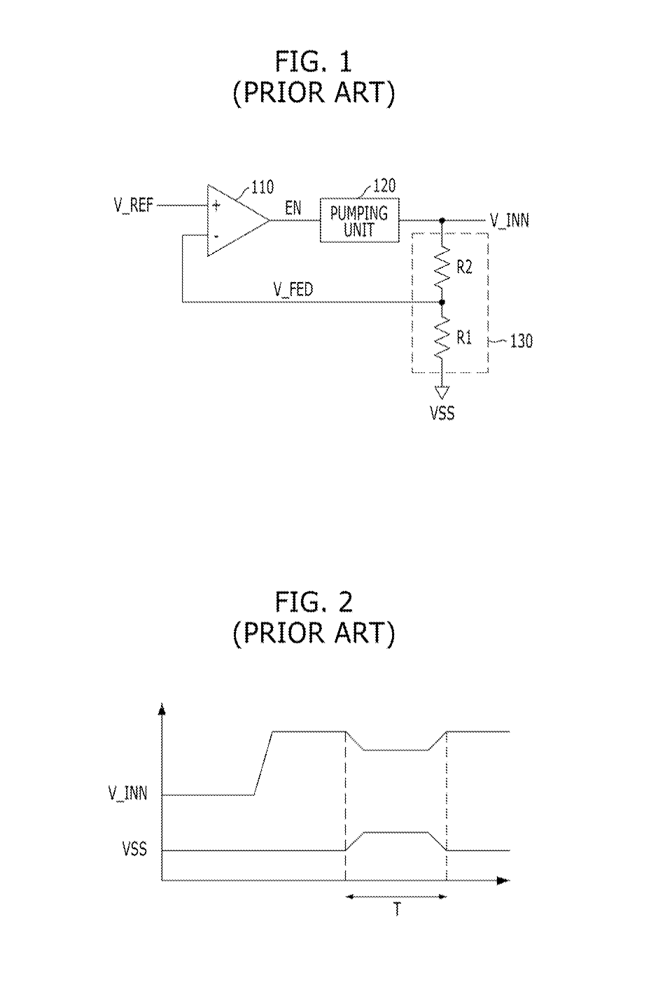

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

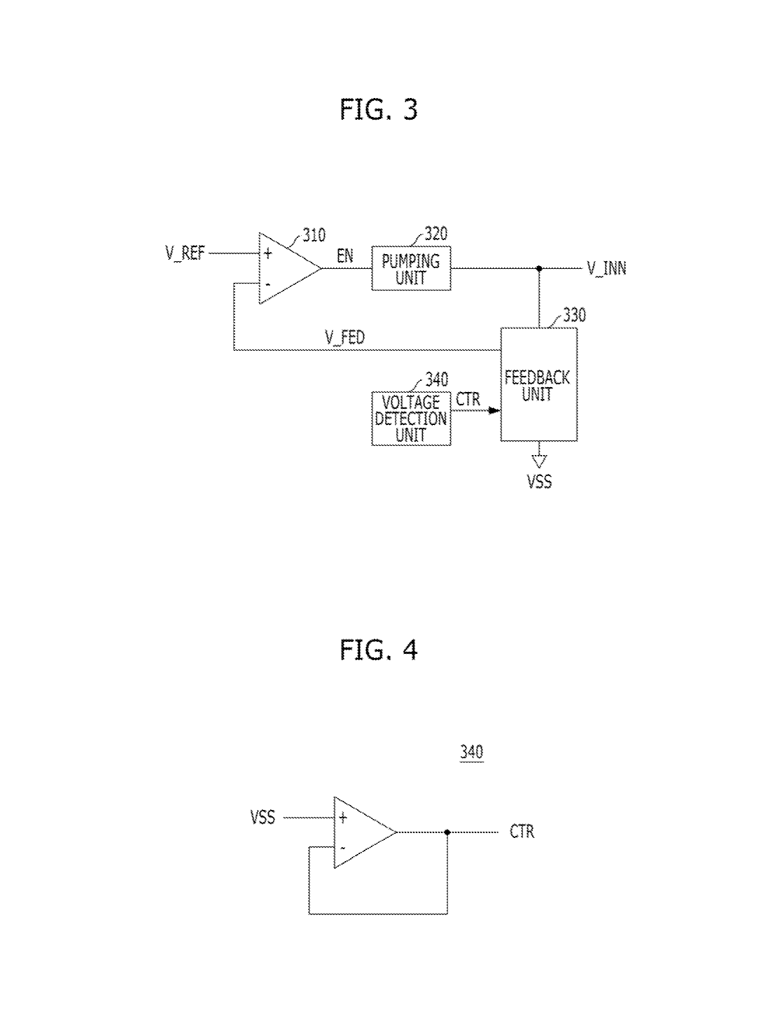

FIG. 3 is a block diagram of an internal voltage generator in accordance with an embodiment of the present invention.

Referring to FIG. 3 the internal voltage generator includes a comparison unit 310, a pumping unit 320, a feedback unit 330, and a voltage detection unit 340.

The comparison unit 310 is configured to compare a voltage level of a feedback voltage V_FED with a reference voltage V_REF and generate an enable signal EN based on a result of the comparison. The pumping unit 320 is configured to generate an internal voltage V_INN through a pumping operation in response to the enable signal EN. As shown in Equation 2, the internal voltage V_INN has a voltage level corresponding to an external ground voltage VSS. The feedback unit 330 is configured to generate the feedback voltage V_FED by dividing the internal voltage V_INN at a given resistance ratio. The voltage detection unit 340 is configured to generate a control signal CTR by detecting a difference between the voltage levels of the external ground voltage VSS and the internal voltage V_INN.

The feedback unit 330 is controlled in response to the control signal CTR. The internal voltage generator in accordance with one embodiment of the present invention may regularly maintain a difference between the voltage levels of the external ground voltage VSS and the internal voltage V_INN through the operation of the feedback unit 330.

An operation of the internal voltage generator of FIG. 3 is described below. It is assumed that the internal voltage V_INN is a positive (+) voltage, for convenience of description.

First, the comparison unit 310 compares a voltage level of the feedback voltage V_FED with the reference voltage V_REF and activates the enable signal EN when the voltage level of the feedback voltage V_FED is lower than the reference voltage V_REF. The pumping unit 320 is enabled in response to the enable signal EN and performs a pumping operation. As a result, the voltage level of the internal voltage V_INN increases to a voltage level corresponding to the reference voltage V_REF. Here, the circuit characteristics of the feedback unit 330 are incorporated into the internal voltage V_INN as shown in Equation 2.

Meanwhile, when the external ground voltage VSS bounces, the voltage detection unit 340 generates the control signal CTR by detecting the bouncing of the external ground voltage VSS. The control signal CTR may control the circuit characteristics of the feedback unit 330. Thus, even when the external ground voltage VSS bounces, a difference between the voltage levels of the external ground voltage VSS and the internal voltage V_INN may remain constant.

In another embodiment, the voltage detection unit 340 may be implemented with a unit gain buffer receiving the external ground voltage VSS, as shown in FIG. 4. In this case, the voltage detection unit 340 generates the control signal CTR based on the bouncing of the external ground voltage VSS to control the circuit characteristics of the feedback unit 330. Thus, even when the external ground voltage VSS bounces, a difference between the voltage levels of the external ground voltage VSS and the internal voltage V_INN may remain constant.

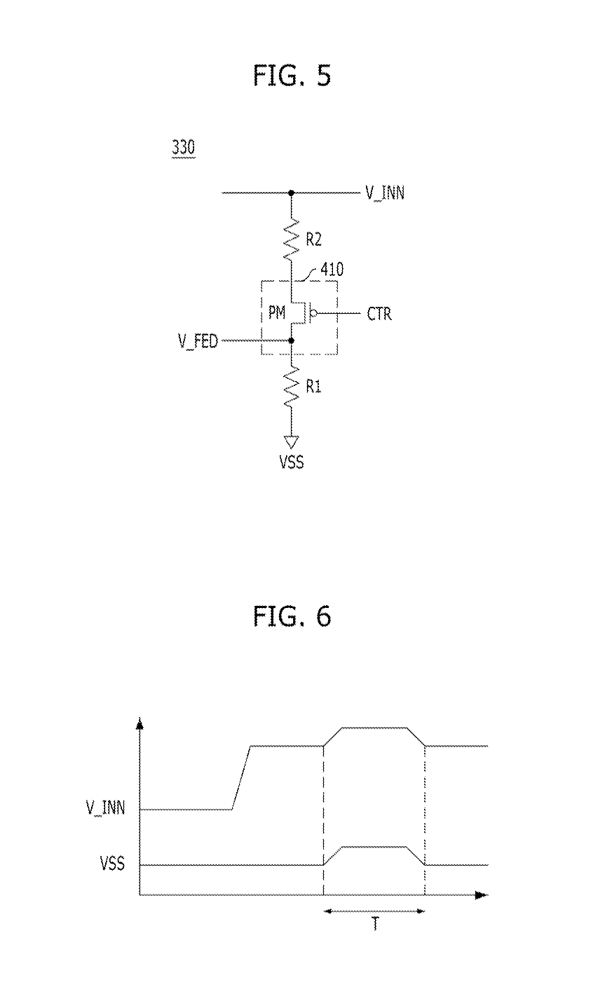

FIG. 5 is a detailed diagram illustrating a first embodiment of the feedback unit 330 shown in FIG. 3.

Referring to FIG. 5, the feedback unit 330 includes a voltage divider R1 and R2 configured to generate the feedback voltage V_FED by incorporating a given resistance ratio into the internal voltage V_INN and a controller 410 configured to control the given resistance ratio in response to the control signal CTR.

The voltage divider R1 and R2 is used to set the given resistance ratio and may be formed of first and second resistors R1 and R2 having a fixed resistance value. Furthermore, the controller 410 is used to control the given resistance ratio, defined by the first and the second resistors R1 and R2, in response to the control signal CTR. The controller 410 is implemented with a PMOS transistor PM which has a source-drain path between the first and the second resistors R1 and R2 and has a gate receiving the control signal CTR.

The voltage level of the control signal CTR increases based on the degree that the external ground voltage VSS bounces. Accordingly, the PMOS transistor PM has an increased resistance value in response to the control signal CTR, and thus, the voltage level of the internal voltage V_INN rises corresponding to the increased resistance value of the PMOS transistor PM.

FIG. 6 is a diagram illustrating the internal voltage V_INN shown in FIG. 5 when the external ground bouncing occurs. The voltage levels of the internal voltage V_INN and the external ground voltage VSS are shown in FIG. 6.

An operation of the internal voltage generator according to the first embodiment is described below with reference to FIGS. 3 to 5.

First, the voltage detection unit 340 detects a voltage level of the external ground voltage VSS. When the external ground voltage VSS bounces, the control signal CTR is activated. That is, the control signal CTR is controlled so that it has a voltage level higher than a default bias voltage in a section T in which the external ground voltage VSS bounces in FIG. 6, and thus, the resistance value of the PMOS transistor PM of FIG. 5 rises. Accordingly, the voltage level of the internal voltage V_INN rises corresponding to the increased resistance value of the PMOS transistor PM in the section T.

As a result, the internal voltage generator in accordance with the first embodiment of the present invention may regularly maintain a difference between the voltage levels of the internal voltage V_INN and the external ground voltage VSS.

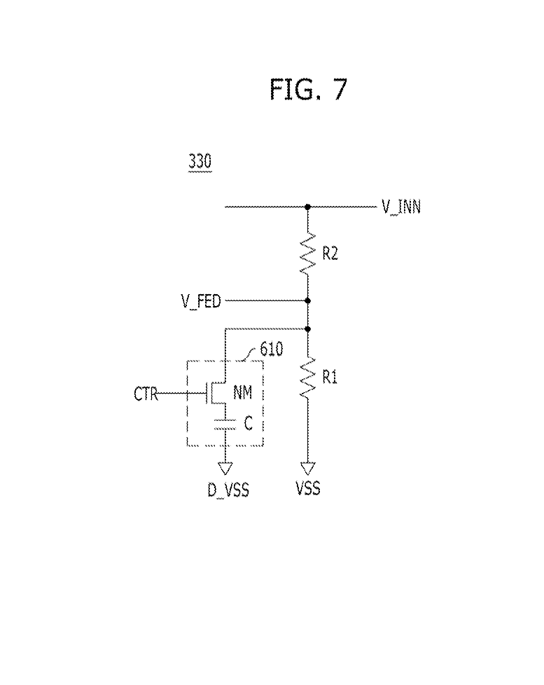

FIG. 7 is a detailed diagram illustrating a second embodiment of the feedback unit 330 show in FIG. 3.

Referring to FIG. 7, the feedback unit 330 includes a voltage divider R1 and R2 configured to generate the feedback voltage V_FED by dividing the internal voltage V_INN at a given resistance ratio, and a controller 610 configured to control a capacitance component, incorporated into the feedback voltage V_FED, in response to the control signal CTR.

The voltage divider R1 and R2 is used to set the given resistance ratio and may be formed of first and second resistors R1 and R2 having a fixed resistance value. Furthermore, the controller 610 may be formed of a capacitor C and an NMOS transistor NM for coupling the capacitor C and the voltage divider R1 and R2 in response to the control signal CTR. The one terminal of the capacitor C may be connected to a terminal for a ground voltage D_VSS separated from the external ground voltage VSS.

In the internal voltage generator in accordance with the second embodiment of the present invention, when the external ground voltage VSS bounces, the control signal CTR is activated, and thus, the NMOS transistor NM is turned on. Accordingly, an increment of the external ground voltage VSS due to the bouncing is charged into the capacitor C. This means that the increment of the external ground voltage VSS may not be incorporated into the internal voltage V_INN. As a result, a difference between the voltage levels of the external ground voltage VSS and the internal voltage V_INN remains relatively constant.

As described above, the internal voltage generator in accordance with the embodiments of the present invention may regularly maintain a difference between the voltage levels of the external ground voltage VSS and the internal voltage V_INN even when the external ground voltage VSS bounces. Accordingly, it may be possible to provide a stable circuit operation for a circuit using the internal voltage V_INN generated as described above.

Furthermore, although an example in which the control signal CTR is inputted to the PMOS transistor PM as shown in FIG. 5 has been described in the first embodiment, the PMOS transistor PM may be replaced with an NMOS transistor depending on the design. Furthermore, although an example in which the control signal CTR is inputted to the NMOS transistor NM as shown in FIG. 7 has been described in the second embodiment, the NMOS transistor NM may be replaced with a PMOS transistor depending on the design.

In addition, in the embodiments, the control signal CTR may be controlled in analog or digital depending on the design. For example, in the embodiments, the position and type of the logic gate and the transistor may be embodied differently depending on the polarity of an input signal. While the present invention has been described with respect to the specific embodiments, it will be apparent to those skilled in the art that various changes and modifications may be made without departing from the spirit and scope of the invention as defined in the following claims.

What is claimed is:

1. An internal voltage generator comprising:
a comparison unit configured to compare a voltage level of a feedback voltage with a reference voltage to generate an enable signal based on a result of the comparison;
an internal voltage generation unit configured to generate an internal voltage in response to the enable signal;
a voltage detection unit configured to generate a control signal by detecting a voltage level of a power source voltage; and
a feedback unit configured to generate the feedback voltage by dividing the internal voltage at a given resistance ratio,
wherein the feedback unit continuously maintains a difference between the voltage levels of the power source voltage and the internal voltage in response to the control signal.

2. The internal voltage generator of claim 1, wherein the voltage detection unit detects a section in which a voltage level of the power source voltage is higher than a given voltage level.

3. The internal voltage generator of claim 2, wherein the voltage detection unit comprises a unit gain buffer configured to be inputted with the power source voltage.

4. The internal voltage generator of claim 1, wherein the voltage detection unit detects a difference between voltage levels of the power source voltage and the internal voltage.

5. The internal voltage generator of claim 1, wherein the power source voltage comprises a ground voltage.

6. An internal voltage generator comprising:
a comparison unit configured to compare a voltage level of a feedback voltage with a reference voltage to generate an enable signal based on a result of the comparison;
an internal voltage generation unit configured to generate an internal voltage in response to the enable signal;
a voltage detection unit configured to generate a control signal by detecting a voltage level of a power source voltage;
a voltage divider configured to generate the feedback voltage by incorporating a given resistance ratio into the internal voltage; and
a controller configured to control the given resistance ratio in response to the control signal.

7. The internal voltage generator of claim 6, wherein:
the voltage divider comprises first and second resistors, each having a fixed resistance value, and
the controller comprises a third resistor coupled between the first and second resistors, the third resistor having a resistance value that is variable in response to the control signal.

8. The internal voltage generator of claim 7, wherein the controller includes a PMOS transistor which has a source-drain path between the first and the second resistors and has a gate receiving the control signal.

9. The internal voltage generator of claim 7, wherein the feedback voltage has a voltage level corresponding to the variable resistance value.

10. The internal voltage generator of claim 7, wherein the resistance value of the controller is varied in a section in which a voltage level of the power source voltage is higher than a given voltage level.

11. The internal voltage generator of claim 6, wherein the voltage detection unit detects a section in which a voltage level of the power source voltage is higher than a given voltage level.

12. An internal voltage generator comprising:
a comparison unit configured to compare a voltage level of a feedback voltage with a reference voltage to generate an enable signal based on a result of the comparison;
an internal voltage generation unit configured to generate an internal voltage in response to the enable signal;
a voltage detection unit configured to generate a control signal by detecting a voltage level of a power source voltage;
a voltage divider configured to generate the feedback voltage by dividing the internal voltage at a given resistance ratio; and
a controller configured to control a capacitance component, incorporated into a feedback voltage terminal, in response to the control signal.

13. The internal voltage generator of claim 12, wherein the controller comprises:
a capacitor; and
a connection unit configured to couple the capacitor and the feedback voltage in response to the control signal.

14. The internal voltage generator of claim 13, wherein the capacitor comprises one terminal connected to the connection unit, and another terminal connected to a poi source voltage separated from the power source voltage.

15. The internal voltage generator of claim 13, wherein the connection unit is turned on in a section in which a voltage level of the power source voltage is higher than a given voltage level.

16. The internal voltage generator of claim 12, wherein the voltage divider comprises first and second resistors coupled in series between a power source voltage terminal and an internal voltage terminal, and outputs the feedback voltage at a common node of the first and second resistors.

17. The internal voltage generator of claim 16, wherein the controller comprises:
a capacitor whose one terminal coupled to a power source voltage separated from the power source voltage; and
a connection unit configured to couple another terminal of the capacitor to the common node of the first and second resistors in response to the control signal.

18. The internal voltage generator of claim 17, wherein the connection unit includes an NMOS transistor which has a source-drain path between another terminal of the capacitor and the common node and has a gate receiving the control signal.

19. The internal voltage generator of claim 12, wherein the voltage detection unit detects a section in which a voltage level of the power source voltage is higher than a given voltage level.

20. The internal voltage generator of claim 12, wherein the voltage detection unit comprises a unit gain buffer configured to be inputted with the power source voltage.
